(19) United States
(12) Patent Application Publication
(10) Pub. No.: US 2017/0017127 A1
(43) Pub. Date: Jan. 19, 2017

(54) DISPLAY PANEL AND DISPLAY DEVICE

(71) Applicant: Shenzhen China Star Optoelectronics Technology Co., Ltd., Shenzhen (CN)

(72) Inventor: Qiming GAN, Shenzhen (CN)

(21) Appl. No.: 14/766,983

(22) PCT Filed: Jul. 13, 2015
(86) PCT No.: PCT/CN2015/083876

§ 371 Date: Aug. 11, 2015

(51) Int. Cl. G02F 1/1343; G02F 1/1362; G02F 1/1335

(52) U.S. Cl. CPC G02F 1/134336; G02F 1/133514; G02F 1/136286; G02F 1/133528; G02F 2001/134318; G02F 2001/134345

(57) ABSTRACT

A liquid crystal display panel is provided. The liquid crystal display panel has an array substrate having a plurality of pixel units disposed thereon. Each of the pixel units has a plurality of sub-pixels. Each of the sub-pixels has a first common electrode, a pixel electrode, and four domains. The domains are formed by patterning the pixel electrode, or by patterning the pixel electrode and the first common electrode simultaneously.

### FIELD OF THE INVENTION

The present invention relates to liquid crystal display technologies, and more particularly to a liquid crystal display panel.

### BACKGROUND OF THE INVENTION

Currently, a IPS (In-Plane-Switching) or FFS (Fringe Field Switching) type liquid crystal panel comprises an array substrate, a color filter substrate, and a liquid crystal layer disposed between the array substrate and the color filter substrate. A pixel electrode and a first common electrode are disposed on a side of the array substrate. The differences between them are: the IPS type liquid crystal display panel has the pixel electrode and the first common electrode located on the same layer, and they have an alternately arranged and spaced distribution; the FFS type liquid crystal display panel has the pixel electrode located on the first common electrode. The liquid crystal molecules of these two types of the liquid crystal display panels are driven by a horizontal electric field between the pixel electrode and the first common electrode, which is parallel to the array substrate and the color filter substrate.

However, the pixel of the current IPS or FFS type liquid crystal panel generally has only two domains, the larger the size of the display panel, the poorer the display effect thereof because the number of the domains is less, which causes the color shift easily.

It is therefore necessary to provide a liquid crystal display panel to solve the problems existing in the conventional technology as described above.

### SUMMARY OF THE INVENTION

An object of the present invention is to provide a liquid crystal display panel to solve the technical problems comprising a smaller angle of view and a color shift that occur in the traditional IPC/FFS type liquid crystal display panel.

To solve the above problems, the present invention provides a liquid crystal display panel, comprising:

a color filter substrate;

an array substrate disposed opposite to the color filter substrate; and

a liquid crystal layer disposed between the color filter substrate and the array substrate;

the array substrate has data lines, scan lines, and a plurality of pixel units disposed thereon, the pixel units are defined by the data lines and the scanning lines, and each of the pixel units comprises a plurality of sub-pixels;

each of the sub-pixels comprises a first common electrode and a pixel electrode, the first common electrode and the pixel electrode are located on the same layer, and alternately arranged and spaced apart from each other;

the sub-pixel has four domains, the four domains are formed by patterning the pixel electrode and patterning the first common electrode; the pixel electrode comprises a horizontal pixel trunk strip, a vertical pixel trunk strip, and pixel branches; the first common electrode comprises a common trunk portion and common branches connected with the common trunk portion, intervals between the pixel branches and the common branches are equal in all of the domains;

the liquid crystal layer contains liquid crystal molecules having an initial orientation in a direction parallel to a direction of the horizontal pixel trunk strip; and an acute angle between an extended line of each of the pixel branches and an extended line of the horizontal pixel trunk strip is 5-15 degrees.

In the liquid crystal display panel of the present invention, the acute angle between the extended line of each of the pixel branches and the extended line of the horizontal pixel trunk strip is 7-12 degrees.

In the liquid crystal display panel of the present invention, the horizontal pixel trunk strip and the vertical pixel trunk strip are perpendicularly crossed with each other, thereby forming four pixel display areas equally; each of the pixel display areas comprises a plurality of the pixel branches, the pixel branches are diverged outward in relation to a crossed center of the horizontal pixel trunk strip and the vertical pixel trunk strip; the plurality of the pixel branches within each of the pixel display areas are spaced apart from each other; and

the first common electrode has four common display areas, each of the common display areas comprises a plurality of the common branches, the common trunk portion surrounds the plurality of common branches, the plurality of the common branches within one of the common display areas are parallel to the plurality of pixel branches within the corresponding pixel display area.

In the liquid crystal display panel of the present invention, the pixel branches within two of the adjacent pixel display areas in a horizontal direction are symmetric with respect to the vertical pixel trunk strip as an axis; and

the pixel branches within two of the adjacent pixel display areas in a vertical direction are symmetric with respect to the horizontal pixel trunk strip as an axis.

In the liquid crystal display panel of the present invention, a first polarizer is disposed outside of the color filter substrate; and a second polarizer is disposed outside of the array substrate.

To solve the above problems, the present invention provides a liquid crystal display panel, comprising:

a color filter substrate;

an array substrate disposed in opposition to the color filter substrate; and

a liquid crystal layer disposed between the color filter substrate and the array substrate;

wherein the array substrate has data lines, scan lines, and a plurality of pixel units disposed thereon, the pixel units are defined by the data lines and the scanning lines, and each of the pixel units comprises a plurality of sub-pixels; and

each of the sub-pixels comprises a first common electrode and a pixel electrode, the sub-pixel has four domains formed by patterning the pixel electrode and patterning the first common electrode. In the liquid crystal display panel of the present invention, the first common electrode and the pixel electrode are located on the same layer, alternately arranged, and spaced apart from each other.

In the liquid crystal display panel of the present invention, the pixel electrode comprises a horizontal pixel trunk strip, a vertical pixel trunk strip, and pixel branches; the horizontal pixel trunk strip and the vertical pixel trunk strip are perpendicularly crossed with each other, thereby forming four pixel display areas equally; each of the pixel display areas comprises a plurality of the pixel branches, the pixel branches are diverged outward in relation to a crossed center of the horizontal pixel trunk strip and the vertical pixel trunk strip; the plurality of the pixel branches within each of the pixel display areas are spaced apart from each other; and

the first common electrode comprises a common trunk portion and common branches connected with the common trunk portion, the first common electrode has four common display areas, each of the common display areas comprises a plurality of the common branches, the common trunk portion surrounds the plurality of common branches, and the plurality of the common branches within one of the common display areas are parallel to the plurality of pixel branches within the corresponding pixel display areas.

In the liquid crystal display panel of the present invention, intervals between the pixel branches and the common branches are equal in all of the domains.

In the liquid crystal display panel of the present invention, the liquid crystal layer contains liquid crystal molecules having an initial orientation in a direction parallel to a direction of the horizontal pixel trunk strip; and

an acute angle between an extended line of each of the pixel branches and an extended line of the horizontal pixel trunk strip is 5-15 degrees.

In the liquid crystal display panel of the present invention, the pixel branches within two of the adjacent pixel display areas in a horizontal direction are symmetric with respect to the vertical pixel trunk strip as an axis; and

the pixel branches within two of the adjacent pixel display areas in a vertical direction are symmetric with respect to the horizontal pixel trunk strip as an axis.

In the liquid crystal display panel of the present invention, the first common electrode comprises a horizontal common trunk strip, a vertical common trunk strip, and common branches; the horizontal common trunk strip and the vertical common trunk strip are perpendicularly crossed with each other, thereby forming four common display areas equally; each of the common display areas comprises a plurality of the common branches, the common branches are diverged outward in relation to a crossed center of the horizontal common trunk strip and the vertical common trunk strip; the plurality of the common branches within each of the common display areas are spaced apart from each other; and

the pixel electrode comprises a pixel trunk portion and pixel branches connected with the pixel trunk portion, the pixel electrode has four pixel display areas, each of the pixel display areas comprises a plurality of the pixel branches, the pixel trunk portion surrounds the plurality of pixel branches, the plurality of the pixel branches within one of the pixel display areas are parallel to the plurality of common branches within the corresponding common display areas.

In the liquid crystal display panel of the present invention, the pixel electrode is located on the first common electrode, and an insulating layer is disposed between the first common electrode and the pixel electrode.

In the liquid crystal display panel of the present invention, the pixel electrode comprises a horizontal pixel trunk strip, a vertical pixel trunk strip, and pixel branches; the horizontal pixel trunk strip and the vertical pixel trunk strip are perpendicularly crossed with each other, thereby forming four pixel display areas equally; each of the pixel display areas comprises a plurality of the pixel branches, the pixel branches are diverged outward in relation to a crossed center of the horizontal pixel trunk strip and the vertical pixel trunk strip; the plurality of the pixel branches within each of the pixel display areas are parallel to and spaced apart from each other.

In the liquid crystal display panel of the present invention, the pixel electrode comprises a pixel trunk portion and pixel branches connected with the pixel trunk portion, the pixel electrode has four pixel display areas, each of the pixel display areas comprises a plurality of the pixel branches, the plurality of the pixel branches within each of the pixel display areas are parallel to and spaced apart from each other, the pixel trunk portion surrounds the plurality of pixel branches;

the pixel branches within two of the adjacent pixel display areas in a horizontal direction are symmetric; and

the pixel branches within two of the adjacent pixel display areas in a vertical direction are symmetric.

The liquid crystal display panel of the present invention solves color shift in a large angle of view by patterning two electrodes on a side of the array substrate to form several domains. The angle of view is increased and the color shift is reduced.

### DESCRIPTION OF THE DRAWINGS

FIG. 1 is a schematic view of an IPS type liquid crystal display panel according to the present invention;

FIG. 2 is a first cross-sectional view taken along a line AA′ in FIG. 1;

FIG. 3 is a second cross-sectional view taken along a line AA′ in FIG. 1; and

FIG. 4 is a schematic view of a FFS type liquid crystal display panel according to the present invention.

### DETAILED DESCRIPTION OF THE PREFERRED EMBODIMENTS

The detailed description of the following embodiments is used for exemplifying the specific embodiments of the present invention by referring to the accompany drawings. Furthermore, directional terms described by the present invention, such as upper, lower, front, back, left, right, inner, outer, side, etc., are only directions by referring to the accompanying drawings, and thus the directional terms are used to describe and understand the present invention, but the present invention is not limited thereto. In the figures, the units having similar structure are represented by the same reference numerals.

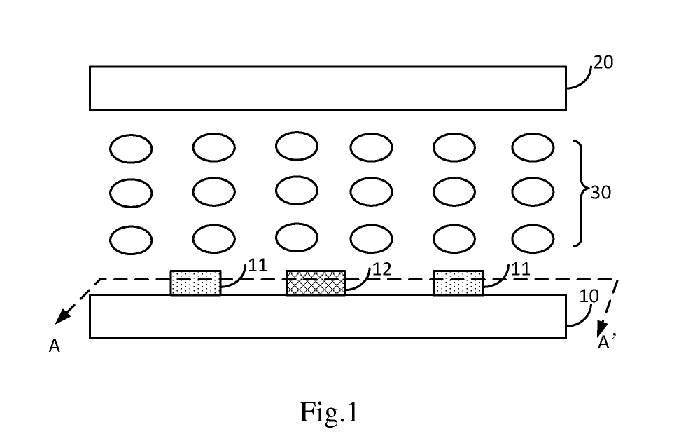

Refer to FIG. 1, which is a schematic view of an IPS type liquid crystal display panel of the present invention.

As shown in FIG. 1, the IPS type liquid crystal display panel comprises a color filter substrate 20, an array substrate 10, and a liquid crystal layer 30. The liquid crystal layer 30 is disposed between the color filter substrate 20 and the array substrate 10. The array substrate 10 is configured in opposition to the color filter substrate 20. A first polarizer can be disposed outside of the color filter substrate 20, and a second polarizer can be disposed outside of the array substrate 10.

A plurality of data lines, scanning lines, and pixel units defined by the data lines and scanning lines can be disposed on the array substrate 10. Each of the pixel units comprises a plurality of sub-pixels. Each of the sub-pixels comprises a pixel electrode 11 and a first common electrode 12. The first common electrode 12 and the pixel electrode 11 are located on the same layer, and alternately arranged and spaced apart from each other. Each of the sub-pixels has four domains formed by patterning the pixel electrode 11 and patterning the first common electrode 12.

The sub-pixel in the traditional IPS type liquid crystal display panel has only two domains. The direction of the electric field between the first common electrode and the pixel electrode of the present invention can be increased by patterning the first common electrode and the pixel electrode so that the liquid crystal molecules have more polarized directions. Since the liquid crystal molecules have more polarized directions, the angle of view is thus increased to reduce the color shift.

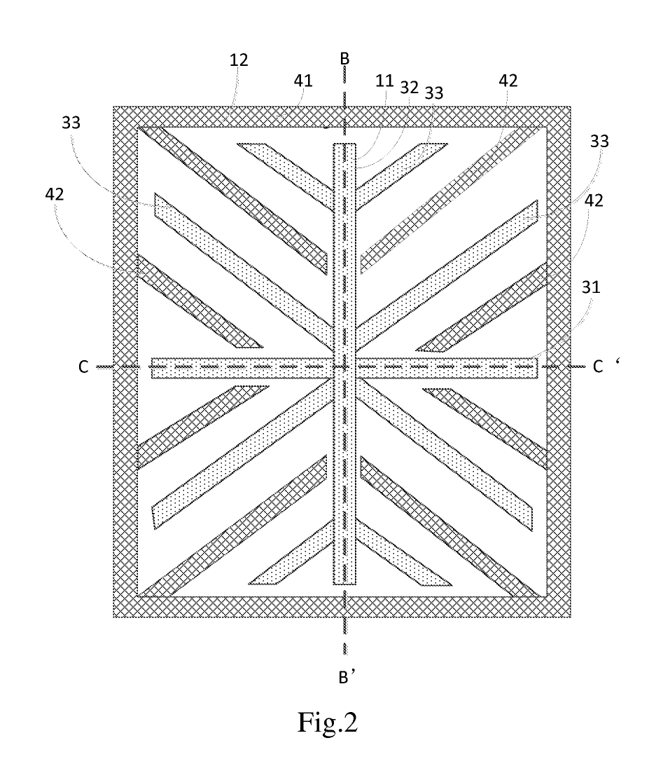

Refer to FIG. 2, which is a first cross-sectional view taken along a line AA′ in FIG. 1.

As shown in FIG. 2, the pixel electrode 11 comprises a horizontal pixel trunk strip 31, a vertical pixel trunk strip 32, and pixel branches 33. The horizontal pixel trunk strip 31 and the vertical pixel trunk strip 32 are perpendicularly crossed with each other, thereby forming four pixel display areas equally; each of the pixel display areas comprises a plurality of the pixel branches 33. The pixel branches are diverged outward in relation to a crossed center of the horizontal pixel trunk strip and the vertical pixel trunk strip, that is, the pixel branches 33 are electrically connected with the horizontal pixel trunk strip 31 or the vertical pixel trunk strip 32. The plurality of the pixel branches 33 within each of the pixel display areas are spaced apart from each other.

The first common electrode 12 comprises a common trunk portion 41 and common branches 42. The first common electrode 12 has four common display areas, for example, the four areas divided by a dashed line BB′ and a dashed line CC′. Each of the common display areas comprises a plurality of the common branches 42. The common trunk portion 41 surrounds the plurality of the common branches 42. The plurality of the common branches 42 are electrically connected with the common trunk portion 41.

The plurality of the common branches 42 within one of the common display areas are parallel to the plurality of pixel branches 33 within the corresponding pixel display area, for example, the common branches 42 within the common display area in the upper right are parallel to the pixel branches 33 within the pixel display area in the upper right.

Preferably, referring to FIG. 2 again, in all of the domains, the intervals between the pixel branches 33 and the common branches 42 are equal. The four common display areas and the corresponding pixel display areas form the four domains. The intervals between the pixel branches and common branches are maintained to be consistent to generate a more uniform electric field between the first common electrode and the pixel electrode so as to promote the display effect efficiently and further reduce the color shift.

Preferably, referring to FIG. 2 again, the liquid crystal layer 30 contains liquid crystal molecules having an initial orientation in the direction parallel to the direction of the horizontal pixel trunk strip 31. An acute angle between an extended line of each of the pixel branches 33 and an extended line of the horizontal pixel trunk strip 31 is 5-15 degrees, with 7-12 degrees being more preferable.

When the initial orientation of the liquid crystal molecules is parallel to the direction of the horizontal pixel trunk strip, and the pixel branches and the horizontal pixel trunk strip are maintained at the abovementioned angle, the specific azimuthal of the liquid crystal molecules can be ensured to benefit deflection of the liquid crystal molecules and promote the display effect.

Preferably, referring to FIG. 2, the pixel branches 33 within two adjacent pixel display areas in a horizontal direction are symmetric with respect to the vertical pixel trunk strip 32 as an axis, for example, the pixel branches within the pixel display areas in upper left and upper right are axially symmetric.

The pixel branches 33 within two adjacent pixel display areas in a vertical direction are symmetric with respect to the horizontal pixel trunk strip 31 as an axis, for example, the pixel branches within the pixel display areas in upper left and lower left are axially symmetric, and the pixel branches within the pixel display areas in upper left and lower right are centrally symmetric. This structure can form two domains having the same orientations of the liquid crystal molecules to avoid the color shift caused by different angles of view.

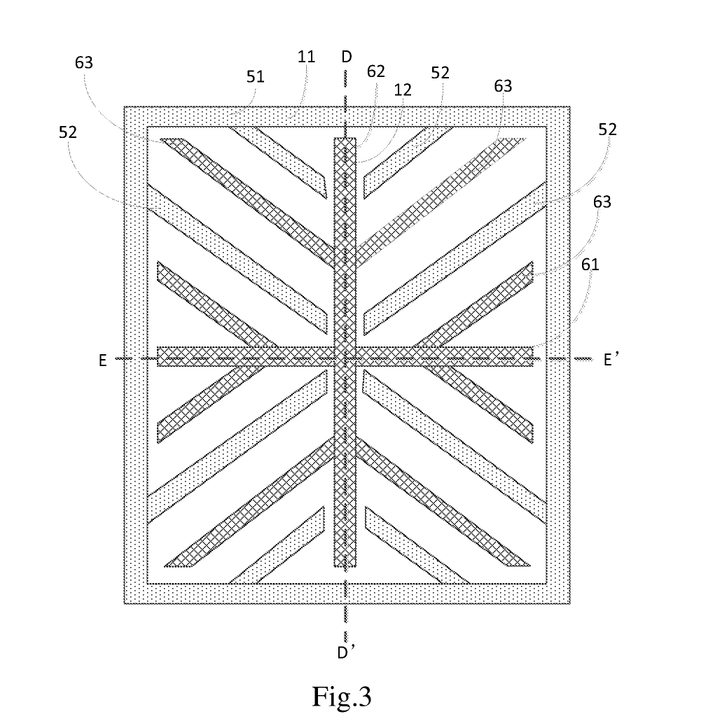

Refer to FIG. 3, which is a second cross-sectional view taken along a line AA′ in FIG. 1.

As shown in FIG. 3, the first common electrode 12 comprises a horizontal common trunk strip 61, a vertical common trunk strip 62 and common branches 63. The horizontal common trunk strip 61 and the vertical common trunk strip 62 are perpendicularly crossed with each other, thereby forming four common display areas equally. Each of the common display areas comprises a plurality of the common branches 63. The common branches 63 are diverged outward in relation to a crossed center of the horizontal common trunk strip 61 and the vertical common trunk strip 62. The plurality of the common branches 63 within each of the pixel display areas are spaced apart from each other.

The pixel electrode 11 comprises a pixel trunk portion 51 and pixel branches 52 connected with the pixel trunk portion. The pixel electrode 11 has four pixel display areas, for example, the four areas divided by a dashed line DD′ and a dashed line EE′. Each of the pixel display areas comprises a plurality of the pixel branches 52. The pixel trunk portion 51 surrounds the plurality of pixel branches 52. The plurality of the pixel branches 52 within one of the pixel display areas are parallel to the plurality of common branches 63 within the corresponding common display areas, for example, the common branches 63 within the common display area in upper right are parallel to the pixel branches 52 within the pixel display area in upper right.

Preferably, referring to FIG. 3 again, in all of the domains, the intervals between the pixel branches 52 and the common branches 63 are equal. The four common display areas and the corresponding pixel display areas form the four domains. The intervals between the pixel branches and common branches are maintained to be consistent to generate an electric field more uniformly between the first common electrode and the pixel electrode so as to promote the display effect efficiently and further reduce the color shift.

Preferably, referring to FIG. 3 again, the liquid crystal layer 30 contains liquid crystal molecules having an initial orientation in the direction parallel to the direction of the horizontal common trunk strip 61. An acute angle between an extended line of each of the common branches 63 and an extended line of the horizontal common trunk strip 61 is 5-15 degrees, with 7-12 degrees being more preferable.

When the initial orientation of the liquid crystal molecules is parallel to the direction of the horizontal common trunk strip, and the common branches and the horizontal common trunk strip are maintained at the abovementioned angle, the specific azimuthal of the liquid crystal molecules can be ensured to benefit deflection of the liquid crystal molecules and promote the display effect.

Preferably, referring to FIG. 3, the common branches 63 within two adjacent pixel display areas in a horizontal direction are symmetric with respect to the vertical common trunk strip 62 as an axis, for example, the common branches within the common display areas in upper left and upper right are axially symmetric.

The common branches 63 within two adjacent pixel display areas in a vertical direction are symmetric with respect to the horizontal common trunk strip 61 as an axis, for example, the common branches within the common display areas in upper left and lower left are axially symmetric, and the common branches within the common display areas in upper left and lower right are centrally symmetric. This structure can form two domains having the same orientations of the liquid crystal molecules to avoid the color shift caused by different angles of view.

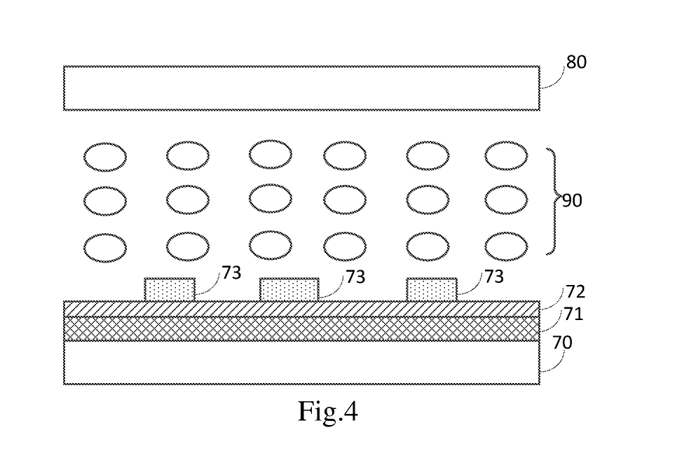

Refer to FIG. 4, which is a schematic view of a FFS type liquid crystal display panel according to one embodiment of the present invention.

As shown in FIG. 4, the FFS type liquid crystal display panel comprises a color filter substrate 80, an array substrate 70, and a liquid crystal layer 90. The liquid crystal layer 30 is disposed between the color filter substrate 80 and the array substrate 70. The array substrate 70 is configured in opposition to the color filter substrate 80. A first polarizer can be disposed outside of the color filter substrate 80, and a second polarizer can be disposed outside of the array substrate 70.

A plurality of data lines, scanning lines and pixel units defined by the data lines and scanning lines can be disposed on the array substrate 70. Each of the pixel units comprises a plurality of sub-pixels. Each of the sub-pixels comprises a pixel electrode 73 and a first common electrode 71. The pixel electrode 73 is located on the first common electrode 71, and an insulating layer 72 is disposed between the first common electrode 71 and the pixel electrode 73.

Each of the sub-pixels has four domains formed by patterning the pixel electrode 73 and patterning the first common electrode 71.

At this time, the pixel electrode 73 has a structure as shown in FIG. 2 or FIG. 3. Refer back to FIG. 2, the pixel electrode comprises a horizontal pixel trunk strip, a vertical pixel trunk strip, and pixel branches. The horizontal pixel trunk strip and the vertical pixel trunk strip are perpendicularly crossed with each other, thereby forming four pixel display areas equally; each of the pixel display areas comprises a plurality of the pixel branches. The pixel branches are diverged outward in relation to a crossed center of the horizontal pixel trunk strip and the vertical pixel trunk strip. The plurality of the pixel branches within each of the pixel display areas are parallel to and spaced apart from each other.

Refer back to FIG. 3, the pixel electrode comprises a pixel trunk portion and pixel branches connected with the pixel trunk portion. The pixel electrode has four pixel display areas. Each of the pixel display areas comprises a plurality of the pixel branches. The plurality of the pixel branches within each of the pixel display areas are parallel to each other and spaced apart from each other. The pixel trunk portion surrounds the plurality of pixel branches.

The pixel branches within two adjacent pixel display areas in a horizontal direction are symmetric with respect to a dashed line DD′ as an axis; and the pixel branches within two adjacent pixel display areas in a vertical direction are symmetric with respect to a dashed line CC′ as an axis.

Because these two types of the pixel electrodes have been described in detail above, they will not be repeated here. In the FFS type liquid crystal display panel, the first common electrode is a single piece of conductive layer.

The sub-pixel in the traditional FFS type liquid crystal display panel has only two domains. The direction of the electric field between the first common electrode and the pixel electrode of the present invention can be increased by patterning the first common electrode and the pixel electrode so that the liquid crystal molecules have more deflected directions. Since the liquid crystal molecules have more deflected directions, the angle of view is thus increased to reduce the color shift.

The liquid crystal display panel of the present invention solves the color shift in a large angle of view by patterning two electrodes on a side of the array substrate to form several domains. The angle of view is increased and the color shift is reduced.

The present invention has been described with preferred embodiments thereof and it is understood that many changes and modifications to the described embodiments can be carried out without departing from the scope and the spirit of the invention that is intended to be limited only by the appended claims.

What is claimed is:

1. A liquid crystal display panel, comprising:
a color filter substrate;
an array substrate disposed opposite to the color filter substrate; and
a liquid crystal layer disposed between the color filter substrate and the array substrate;
wherein the array substrate has data lines, scan lines, and a plurality of pixel units disposed thereon, the pixel units are defined by the data lines and the scanning lines, and each of the pixel units comprises a plurality of sub-pixels;
wherein each of the sub-pixels comprises a first common electrode and a pixel electrode, the first common electrode and the pixel electrode are located on the same layer, and alternately arranged and spaced apart from each other;
wherein each of the sub-pixels has four domains formed by patterning the pixel electrode and patterning the first common electrode; the pixel electrode comprises a horizontal pixel trunk strip, a vertical pixel trunk strip, and pixel branches; the first common electrode comprises a common trunk portion and common branches connected with the common trunk portion, intervals between the pixel branches and the common branches are equal in all of the domains;
wherein the liquid crystal layer contains liquid crystal molecules having an initial orientation in a direction parallel to a direction of the horizontal pixel trunk strip; and an acute angle between an extended line of each of the pixel branches and an extended line of the horizontal pixel trunk strip is 5-15 degrees.

2. The liquid crystal display panel according to claim 1, wherein the acute angle between the extended line of each of the pixel branches and the extended line of the horizontal pixel trunk strip is 7-12 degrees.

3. The liquid crystal display panel according to claim 1, wherein the horizontal pixel trunk strip and the vertical pixel trunk strip are perpendicularly crossed with each other, thereby forming four pixel display areas equally; each of the pixel display areas comprises a plurality of the pixel branches, the pixel branches are diverged outward in relation to a crossed center of the horizontal pixel trunk strip and the vertical pixel trunk strip; the plurality of the pixel branches within each of the pixel display areas are spaced apart from each other; and
wherein the first common electrode has four common display areas, each of the common display areas comprises a plurality of the common branches, the common trunk portion surrounds the plurality of common branches, the plurality of the common branches within one of the common display areas are parallel to the plurality of pixel branches within the corresponding pixel display area.

4. The liquid crystal display panel according to claim 3, wherein the pixel branches within two of the adjacent pixel display areas in a horizontal direction are symmetric with respect to the vertical pixel trunk strip as an axis; and
wherein the pixel branches within two of the adjacent pixel display areas in a vertical direction are symmetric with respect to the horizontal pixel trunk strip as an axis.

5. The liquid crystal display panel according to claim 1, wherein a first polarizer is disposed outside of the color filter substrate; and a second polarizer is disposed outside of the array substrate.

6. A liquid crystal display panel, comprising:
a color filter substrate;
an array substrate disposed in opposition to the color filter substrate; and
a liquid crystal layer disposed between the color filter substrate and the array substrate;
wherein the array substrate has data lines, scan lines, and a plurality of pixel units disposed thereon, the pixel units are defined by the data lines and the scanning lines, and each of the pixel units comprises a plurality of sub-pixels;
wherein each of the sub-pixels comprises a first common electrode and a pixel electrode, the sub-pixel has four domains, the four domains are formed by patterning the pixel electrode and patterning the first common electrode.

7. The liquid crystal display panel according to claim 6, wherein the first common electrode and the pixel electrode are located on the same layer, and alternately arranged and spaced apart from each other.

8. The liquid crystal display panel according to claim 7, wherein the pixel electrode comprises a horizontal pixel trunk strip, a vertical pixel trunk strip, and pixel branches; the horizontal pixel trunk strip and the vertical pixel trunk strip are perpendicularly crossed with each other, thereby forming four pixel display areas equally; each of the pixel display areas comprises a plurality of the pixel branches, the pixel branches are diverged outward in relation to a crossed center of the horizontal pixel trunk strip and the vertical pixel trunk strip; the plurality of the pixel branches within each of the pixel display areas are spaced apart from each other; and
wherein the first common electrode comprises a common trunk portion and common branches connected with the common trunk portion, the first common electrode has four common display areas, each of the common display areas comprises a plurality of the common branches, the common trunk portion surrounds the plurality of common branches, and the plurality of the common branches within one of the common display areas are parallel to the plurality of pixel branches within the corresponding pixel display areas.

9. The liquid crystal display panel according to claim 8, wherein intervals between the pixel branches and the common branches are equal in all of the domains.

10. The liquid crystal display panel according to claim 8, wherein the liquid crystal layer contains liquid crystal molecules having an initial orientation in a direction parallel to a direction of the horizontal pixel trunk strip; and an acute angle between an extended line of each of the pixel branches and an extended line of the horizontal pixel trunk strip is 5-15 degrees.

11. The liquid crystal display panel according to claim 8, wherein the pixel branches within two of the adjacent pixel display areas in a horizontal direction are symmetric with respect to the vertical pixel trunk strip as an axis; and
wherein the pixel branches within two of the adjacent pixel display areas in a vertical direction are symmetric with respect to the horizontal pixel trunk strip as an axis.

12. The liquid crystal display panel according to claim 7, wherein the first common electrode comprises a horizontal common trunk strip, a vertical common trunk strip, and common branches; the horizontal common trunk strip and the vertical common trunk strip are perpendicularly crossed with each other, thereby forming four common display areas equally; each of the common display areas comprises a plurality of the common branches, the common branches are diverged outward in relation to a crossed center of the horizontal common trunk strip and the vertical common trunk strip; the plurality of the common branches within each of the common display areas are spaced apart from each other; and
wherein the pixel electrode comprises a pixel trunk portion and pixel branches connected with the pixel trunk portion, the pixel electrode has four pixel display areas, each of the pixel display areas comprises a plurality of the pixel branches, the pixel trunk portion surrounds the plurality of pixel branches, the plurality of the pixel branches within one of the pixel display areas are parallel to the plurality of common branches within the corresponding common display areas.

13. The liquid crystal display panel according to claim 6, wherein the pixel electrode is located on the first common electrode, and an insulating layer is disposed between the first common electrode and the pixel electrode.

14. The liquid crystal display panel according to claim 13, wherein pixel electrode comprises a horizontal pixel trunk strip, a vertical pixel trunk strip, and pixel branches; the horizontal pixel trunk strip and the vertical pixel trunk strip are perpendicularly crossed with each other, and thereby forming four pixel display areas equally; each of the pixel display areas comprises a plurality of the pixel branches, the pixel branches are diverged outward in relation to a crossed center of the horizontal pixel trunk strip and the vertical pixel trunk strip; the plurality of the pixel branches within each of the pixel display areas are parallel to and spaced apart from each other.

15. The liquid crystal display panel according to claim 13, wherein the pixel electrode comprises a pixel trunk portion and pixel branches connected with the pixel trunk portion, the pixel electrode has four pixel display areas, each of the pixel display areas comprises a plurality of the pixel branches, the plurality of the pixel branches within each of the pixel display areas are parallel to and spaced apart from each other, the pixel trunk portion surrounds the plurality of pixel branches;
wherein the pixel branches within two of the adjacent pixel display areas in a horizontal direction are symmetric; and
wherein the pixel branches within two of the adjacent pixel display areas in a vertical direction are symmetric.
